(19) United States
(12) Patent Application Publication
(10) Pub. No.: US 2024/0032098 A1
(43) Pub. Date: Jan. 25, 2024

(54) OPTIONALLY PERFORMING A LISTEN-BEFORE-TALK OPERATION

(71) Applicant: Lenovo (Singapore) Pte. Ltd., New Tech Park (SG)

(72) Inventors: Karthikeyan Ganesan, Kronberg im Taunus (DE); Ankit Bhamri, Rödermark (DE); Alexander Johann Maria Golitschek Edler von Elbwart, Darmstadt (DE); Ali Ramadan Ali, Kraiburg am Inn (DE)

(21) Appl. No.: 18/256,499

(22) PCT Filed: Dec. 6, 2021
(86) PCT No.: PCT/IB2021/061377

§ 371 Date: Jun. 8, 2023

Related U.S. Application Data
(60) Provisional application No. 63/122,855, filed on Dec. 8, 2020.

(51) Int. Cl. H04W 74/08; H04W 76/20

(52) U.S. Cl. CPC H04W 74/0816; H04W 76/20

(57) ABSTRACT

Apparatuses, methods, and systems are disclosed for optionally performing a listen-before-talk operation. One method includes configuring communications in an unlicensed spectrum to use a listen-before-talk mode of operation, a non-listen-before-talk mode of operation, or a combination thereof. In some embodiments, the method includes receiving information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

### CROSS-REFERENCE TO RELATED APPLICATIONS

This application claims priority to U.S. Patent Application Ser. No. 63/122,855 entitled “APPARATUSES, METHODS, AND SYSTEMS FOR CONFIGURATION, SIGNALING, AND PROCEDURES FOR SWITCHING BETWEEN LBT AND NO-LBT” and filed on Dec. 8, 2020 for Karthikeyan Ganesan, which is incorporated herein by reference in its entirety.

### FIELD

The subject matter disclosed herein relates generally to wireless communications and more particularly relates to optionally performing a listen-before-talk operation.

### BACKGROUND

In certain wireless communications networks, listen-before-talk operations may be performed. In such networks, listen-before-operations may overload resources.

### BRIEF SUMMARY

Methods for optionally performing a listen-before-talk operation are disclosed. Apparatuses and systems also perform the functions of the methods. One embodiment of a method includes configuring, at a user equipment, communications in an unlicensed spectrum to use a listen-before-talk mode of operation, a non-listen-before-talk mode of operation, or a combination thereof. In some embodiments, the method includes receiving information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

One apparatus for optionally performing a listen-before-talk operation includes a user equipment. In some embodiments, the apparatus includes a processor that configures communications in an unlicensed spectrum to use a listen-before-talk mode of operation, a non-listen-before-talk mode of operation, or a combination thereof. In various embodiments, the apparatus includes a receiver that receives information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

Another embodiment of a method for optionally performing a listen-before-talk operation includes configuring, at a network unit, communications in an unlicensed spectrum to use a listen-before-talk mode of operation, a non-listen-before-talk mode of operation, or a combination thereof. In some embodiments, the method includes transmitting information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling.

Another apparatus for optionally performing a listen-before-talk operation includes a network unit. In some embodiments, the apparatus includes a processor that configures communications in an unlicensed spectrum to use a listen-before-talk mode of operation, a non-listen-before-talk mode of operation, or a combination thereof. In various embodiments, the apparatus includes a transmitter that transmits information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for optionally performing a listen-before-talk operation;

FIG. 2 is a schematic block diagram illustrating one embodiment of an apparatus that may be used for optionally performing a listen-before-talk operation;

FIG. 3 is a schematic block diagram illustrating one embodiment of an apparatus that may be used for optionally performing a listen-before-talk operation;

FIG. 4 is a schematic block diagram illustrating one embodiment of a system for optionally performing a listen-before-talk operation;

FIG. 5 is a flow chart diagram illustrating one embodiment of a method for optionally performing a listen-before-talk operation; and

FIG. 6 is a flow chart diagram illustrating another embodiment of a method for optionally performing a listen-before-talk operation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

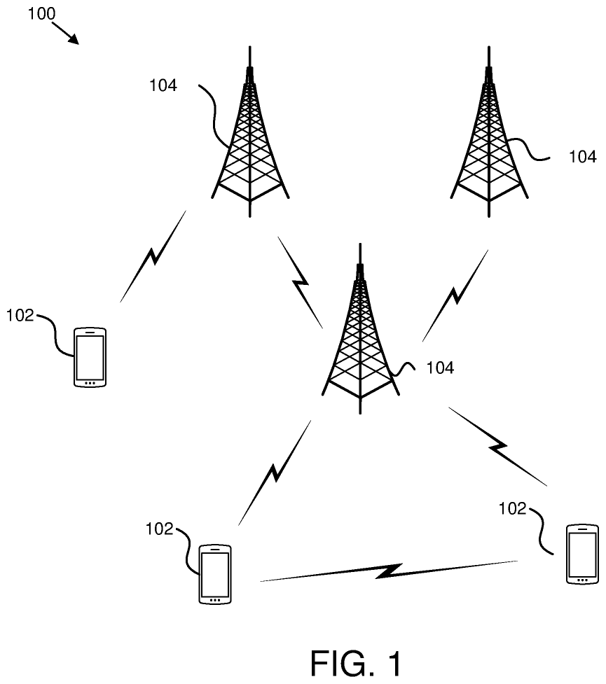

FIG. 1 depicts an embodiment of a wireless communication system 100 for optionally performing a listen-before-talk operation. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may configure communications in an unlicensed spectrum to use a listen-before-talk mode of operation, a non-listen-before-talk mode of operation, or a combination thereof. In some embodiments, the remote unit 102 may receive information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling. Accordingly, the remote unit 102 may be used for optionally performing a listen-before-talk operation.

In certain embodiments, a network unit 104 may configure communications in an unlicensed spectrum to use a listen-before-talk mode of operation, a non-listen-before-talk mode of operation, or a combination thereof. In some embodiments, the network unit 104 may transmit information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling. Accordingly, the network unit 104 may be used for optionally performing a listen-before-talk operation.

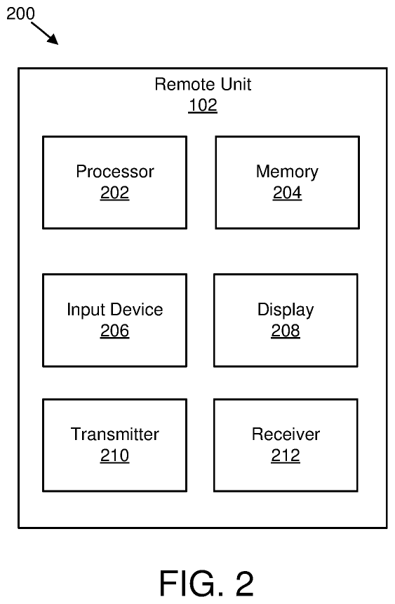

FIG. 2 depicts one embodiment of an apparatus 200 that may be used for optionally performing a listen-before-talk operation. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 configures communications in an unlicensed spectrum to use a listen-before-talk mode of operation, a non-listen-before-talk mode of operation, or a combination thereof. In various embodiments, the receiver 212 receives information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

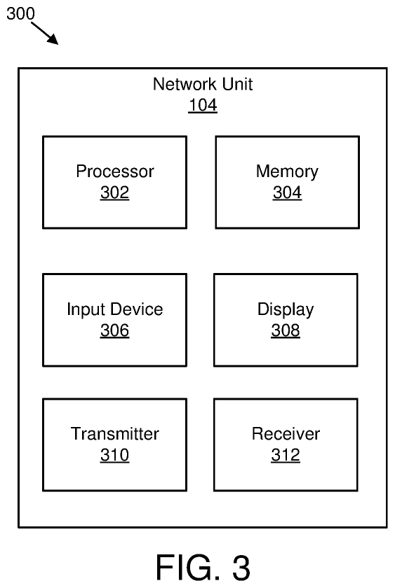

FIG. 3 depicts one embodiment of an apparatus 300 that may be used for optionally performing a listen-before-talk operation. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 configures communications in an unlicensed spectrum to use a listen-before-talk mode of operation, a non-listen-before-talk mode of operation, or a combination thereof. In various embodiments, the transmitter 310 transmits information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling.

In certain networks, listen-before talk (“LBT”) may not be used. In such networks, no-LBT type transmissions may be made; however, to maintain coexistence with Wi-Fi and other operators, usage of LBT may be preferred. In some embodiments, there may be operation of a no-lo LBT mode if there is low interference and there may be a fallback mode of switching from no-LBT to LBT.

In various embodiments, there may be a procedure and signaling for dynamic LBT (e.g., switching from LBT to no-LBT and vice versa) which may consider channel occupancy, beams, and so forth.

In certain embodiments there may be: 1) different configuration and signaling options for the transmission of a switching indication per beam for switching between LBT to no-LBT and vice versa; 2) a user equipment (“UE”) initiated switching per beam between LBT to no-LBT and vice versa; 3) different UE procedures for describing switching between LBT and no-LBT mode and vice versa for a beam; and/or 4) different UE procedures describing LBT and no-LBT mode considering different beams.

In a first embodiment, there may be a configuration of LBT and no-LBT mode per beam basis. According to the first embodiment, in a cell containing users with both LBT and no-LBT modes, then the LBT and no-LBT mode configuration may be defined per beam and/or per a spatial filter.

For transition from LBT to No-LBT, long term interference statistics such as layer 3 (“L3”) reference signal received power (“RSRP”) (“L3-RSRP”) and/or reference signal received quality (“RSRQ”) measured in a configured window duration defined in terms of slots, msec per beam, spatial filter, and/or quasi-co-located (“QCLed”) assumptions are compared against a configured interference threshold and, if the measured interference is below the configured threshold for a beam and/or spatial filter then the transmitter (e.g., such as a gNB or a UE), may switch the beam and/or the spatial filter from LBT to no-LBT mode. In some embodiments, hybrid automatic repeat request (“HARQ”) acknowledgement (“ACK”) (“HARQ-ACK”) reported in a configured window duration that is defined in terms of slots, msec per beam, and/or spatial filter may be used as a metric to detect interference by measuring a percentage or ratio of ACKs against non-acknowledgements (“NACKs”) in a configured window and, if that percentage or ratio is above certain configured threshold, then the gNB may switch the beam and/or spatial filter from an LBT mode to a no-LBT mode. In various embodiments, a percentage or ratio is reported by a receiver to a transmitter. In certain embodiments, a consecutive number of ACKs exceeding a threshold may be used as a metric for switching from LBT to no-LBT. In some embodiments, a consecutive number or whether the consecutive number exceeds a threshold is reported by a receiver to a transmitter. In various embodiments, a threshold is determined or configured by a network or communication system.

For no-LBT to LBT: 1) a counter may be defined, and the counter value is incremented each time if the consecutive NACKs or discontinuous transmission (“DTX”) is above a certain configured threshold value and, if the counter value is above the certain configured threshold, then the transmitter may decide to switch from an no-LBT to an LBT mode; 2) measured long term interference statistics such as L3-RSRP and/or RSRQ above a certain configured threshold may be used as a criterion for the transmitter to switch to the LBT mode; 3) by measuring a percentage or ratio of NACKs and/or DTX against ACKs in a configured window above the certain configured threshold may be used; and/or 4) consecutive NACKs or DTX may be a metric for switching to the LBT mode.

In certain embodiments, a gNB may transmit a switching indicator that may be a one-bit indication for an LBT mode or a no-LBT mode. As an example, the switching indicator having a value of “0” may indicate a no-LBT mode and the value of “1” may indicate an LBT mode.

In some embodiments, a separate group common downlink configuration indicator (“DCI”) may be used and a radio network temporary identifier (“RNTI”) may be used for monitoring the separate group common DCI. The RNTI may be different from another RNTI used for a group common DCI so that the receiver may distinguish group common DCIs by the RNTI. In various embodiments, group common DCI format 2-0 may be extended with a field (e.g., using reserved bits) to indicate a switching indicator. In certain embodiments, DCI providing a UL grant may be extended with a field to indicate a switching indicator.

In some embodiments, semi-static signaling, such as RRC signaling, may be used to signal a switching indicator. In various embodiments, a new medium access control (“MAC”) control element (“CE”) may be defined, or an existing MAC CE may be extended to provide a switching indicator. In certain embodiments, radio resource control (“RRC”) common signaling may indicate LBT or no-LBT for a beam, quasi-co-location (“QCL”), or set of beams.

In some embodiments, signaling of LBT and no-LBT and vice versa switching may be transmitted only in relevant beams where the switching is to be performed.

In various embodiments, whether a UE needs to perform a cat 4 type LBT or a cat 2 type LBT for switching from no-LBT to LBT may be specified. In certain embodiments, a configurable sensing duration of a cat 2 type LBT and/or applicability of a random back off and/or fixed or variable contention window size may be specified.

In certain embodiments, signaling may contain at least one additional parameter.

In some embodiments, the at least one additional parameter may include a duration of LBT or no-LBT mode of operation per beam or set of beams. In such embodiments, the UE is informed, within a switching signaling method, of a duration in terms of slots or msec for the LBT mode or no-LBT mode to be active. In one implementation of such embodiments, duration may be signaled as a maximum channel occupancy time (“MCOT”) duration for LBT mode or no-LBT mode signaled using DCI or using RRC and/or MAC CE and the duration is measured from the starting symbol of a first slot (e.g., after the switching) to the last symbol of a slot. In another implementation of such embodiments, an index of a table containing a value of a duration is signaled to the UE.

In various embodiments, the at least one additional parameter may include to indicate an LBT or no-LBT mode to be used after a specified duration. The UE is informed, within a switching method, with information that specifies UE behavior after finishing the specified duration. In one implementation of such embodiments, if the UE is asked to switch from a first mode (e.g., LBT) to a second mode (e.g., no-LBT) for a certain duration, then after finishing the duration, an explicit indication (e.g., one bit) may inform the UE about whether to continue using the second mode or fallback to the first mode.

In certain embodiments, the at least one additional parameter may include an explicit indication that may be transmitted using DCI, RRC signaling, or MAC CE. Absence of any explicit indication from a gNB may make a UE return to a configured (or preconfigured) fallback mode (e.g., an LBT mode).

In some embodiments, the at least one additional parameter may start an LBT or no-LBT mode of operation per beam or set of beams. The UE is informed, within a switching method, about when to switch (e.g., relative time offset in terms of symbols, slots, and/or msec may be specified). Offset may be calculated from a last symbol of a slot where it received the signaling. DCI, RRC signaling, or MAC CE may carry this offset.

In various embodiments, the at least one additional parameter may include beam specific details like QCL assumptions in which an LBT and/or no-LBT is applicable. RRC common signaling may indicate LBT or no-LBT for a beam, QCL, or set of beams. In such embodiments, DCI signaling may indicate a TCI state for which the LBT and/or no-LBT is applicable.

In certain embodiments, the at least one additional parameter may include a flag to indicate a new radio unlicensed (“NR-U”) mechanism for a no-LBT mode. In such embodiments, the UE is signaled separately about handling of a NR-U mechanism for the no-LBT mode like autonomous selection of a HARQ process identifier (“ID”), a configured grant (“CG”) retransmission timer, and/or search space switching to indicate whether the no-LBT mode is allowed or not allowed.

In certain embodiments, there may be a configured set (or preconfigured set) of CG resource for LBT and no-LBT modes that are signaled to the UE and the UE may activate and/or deactivate resources from those configured CG resource based on a switching indication. In one implementation, a switching indicator itself activates and/or deactivates corresponding CG resource from the configured set. In another implementation, a separate signaling for activation and/or deactivation may be RRC or DCI signaling.

In some embodiments, there may be UE requested switching from an LBT to a no-LBT mode such as: 1) UE initiated switching from LBT to no-LBT mode may be performed by transmitting a request for switching using a specific scheduling resource (“SR”) configuration or specific random access channel (“RACH”) preamble—the RACH preamble may be beneficially an indicated or configured preamble so that the corresponding RACH procedure is contention-free; 2) the UE may transmit a SR and/or RACH preamble if a measured interference level is below a certain configured threshold—in one implementation, a UE, after encountering configurable LBT failures and/or based on a priority (e.g., reliability and/or latency) of the data transmission, may be allowed to switch to the No-LBT mode by embodiments described herein; and/or 3) a gNB may decide to accept or deny a request for switching from UE based on aggregated measurements from UEs served by that beam and/or set off beams. In response to a request from the UE, the gNB may transmit the switching indicator as described using embodiments described herein.

In various embodiments, there may be autonomous switching from an LBT to a no-LBT mode such as: 1) interference level measurement may be associated with the autonomous switching and, as an example, with an interference level lower than a threshold, switching from LBT to no-LBT is enabled and while at an interference level higher than a threshold, short LBT of cat 2 is performed; 2) configurable sensing duration for cat 2 may be defined such that longer sensing duration may be configured for a high reliability traffic type; and/or 3) separation of cat 2, cat 4, and no-LBT mode of access may configured per logical channel (“LCH”), or otherwise classified based on channel access priority class (“CAPC”) values.

In certain embodiments, there may be autonomous switching from a no-LBT to an LBT mode such as: 1) a gNB or a UE may autonomously switch from no-LBT to LBT mode based on a configurable percentage or ratio of received NACKs to ACKs, or based on a number of consecutive NACKs—for example, a high ratio of NACKs to ACKs or a large number of consecutive NACKS for transmissions may be a sign that the transmissions faced adverse effects caused by collisions on the channel—in such a case, going to LBT mode to avoid collisions may improve the data transmission of the UE, as well as of other transmitters in the system; 2) an interference level measurement may be a metric for autonomous switching from no-LBT to LBT—as an example, for an interference level higher than a threshold, the gNB or UE may autonomously switch from no-LBT to LBT—the detailed LBT category, such as Cat 2 or Cat 4, may be defined (e.g., per traffic type and/or beam); and/or 3) for unlicensed access in regions where both LBT and no-LBT based channel access mechanism can be employed, the LBT type to be used may be associated with the traffic and/or UE priority type. In one implementation, an ultra-reliable low-latency communication (“URLLC”) device is associated with no-LBT based channel access mechanism and enhanced mobile broadband (“eMBB”) device is associated with only LBT-based channel access mechanism. In some embodiments, a same device with two different priority traffic such as eMBB traffic and URLLC traffic may be configured to use both LBT and no-LBT type for intra-UE multiplexing of eMBB and URLLC. In various embodiments, eMBB traffic and/or the UE may be associated with both LBT and no-LBT based channel access mechanisms, where the UE is required first to perform LBT based channel access at least for N number of times (e.g., configured and/or indicated by a network) and upon failure for all N instances, the UE is allowed to perform a no-LBT based channel access mechanism. In certain embodiments, URLLC traffic and/or a UE may be associated with both LBT and no-LBT based channel access mechanisms, where the UE is required first to perform LBT based channel access at least for M number of times (e.g., configured and/or indicated by a network and M is less than or equal to N, N being the counter for eMBB UE and/or traffic) and upon failure for all M instances, the UE is allowed to perform a no-LBT based channel access mechanism.

In a second embodiment, there may be a UE procedure for switching between LBT and no-LBT modes. According to the second embodiment, there may be at least a first case, a second case, and a third case for switching from the LBT mode to the no-LBT mode and vice versa.

In the first case, there may be switching from the LBT mode to the no-LBT mode. If a UE receives an LBT to no-LBT switching indication for a beam, a configurable gap (or no gap) may be applied before starting no-LBT. One or more of the following may be applied during switching: 1) the UE waits until any on-going transmission within a current remaining channel occupancy time (“COT”) initiated based on LBT is finished before switching to the no-LBT mode, where the no-LBT mode is initiated using a new COT (e.g., if MCOT is configured to be used in the no-LBT mode); 2) the UE switches to the No-LBT mode immediately in the current remaining COT—after the COT ends, the UE uses the no-LBT mode using a new COT (e.g., if MCOT is configured to be used in a no-LBT mode); 3) the UE ends the current COT initiated based on LBT immediately and switches to no-LBT mode using a new COT (e.g., if MCOT is configured for the no-LBT mode); 4) a separate MCOT may be defined for the LBT mode and the no-LBT mode; and/or 5) the gNB may semi-statically or dynamically indicate one of these options to be used along with the switching indicator.

In the second case, there may be switching from the no-LBT mode to the LBT mode. If a UE receives a no-LBT to LBT switching indication for a beam, a configurable gap may be applied before starting the LBT mode of operation. One of the following may be applied during switching: 1) the UE waits until any on-going transmission within the current remaining COT initiated based on no-LBT (e.g., if MCOT is configured to be used in the no-LBT mode) is finished before switching to the LBT mode, where the LBT mode is initiated using a new COT; 2) the UE switches to the LBT mode immediately in the ongoing COT with a configurable gap (or zero gap) applied before starting the LBT mode of operation—an LBT of cat 2 is performed when switching from no-LBT to LBT in the ongoing COT; 3) the UE ends the current COT immediately and switches to the LBT mode using a new COT—the new COT is initiated based on cat 4 or cat 2; and/or 4) the gNB may semi-statically or dynamically indicate one of these options to be used along with the switching indicator.

In the third case, there may be LBT and/or no-LBT modes of operation in different beams (e.g., multiple beams). The UE may perform the LBT mode and the no-LBT mode parallelly in different beams using different MCOT durations. In other words, the UE may initiate the LBT mode or the no-LBT mode in different beams independently using a new COT. If a COT is associated with more than one beam and, if a switching indication from LBT to no-LBT is received, the UE switches to no-LBT only after the completion of the ongoing COT.

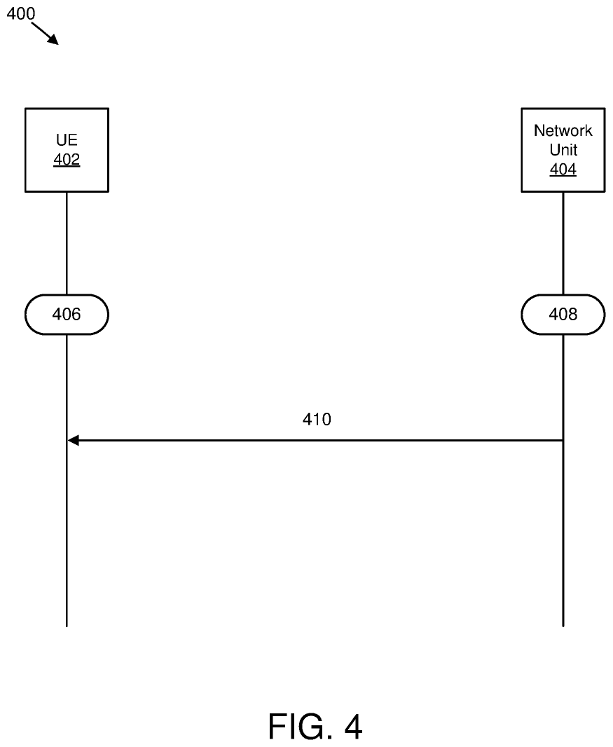

FIG. 4 is a schematic block diagram illustrating one embodiment of a system 400 for optionally performing a listen-before-talk operation. The system 400 includes a UE 402 and a network unit 404. In some embodiments, the UE 402 may configure 406 communications in an unlicensed spectrum to use a listen-before-talk mode of operation, a non-listen-before-talk mode of operation, or a combination thereof. In various embodiments, the network unit 404 may configure 408 communications in an unlicensed spectrum to use a listen-before-talk mode of operation, a non-listen-before-talk mode of operation, or a combination thereof. In certain embodiments, the network unit 404 may transmit 410 information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling

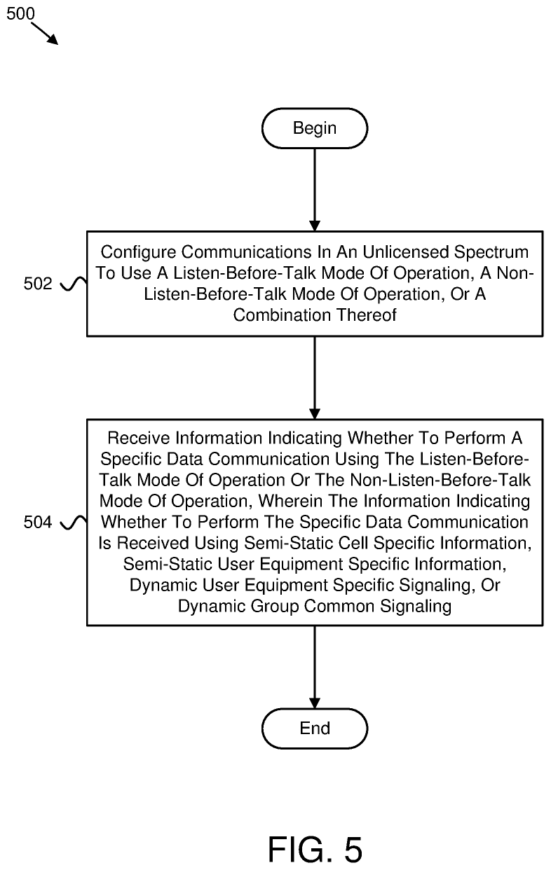

FIG. 5 is a flow chart diagram illustrating one embodiment of a method 500 for optionally performing a listen-before-talk operation. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes configuring 502 communications is in an unlicensed spectrum to use a listen-before-talk mode of operation, a non-listen-before-talk mode of operation, or a combination thereof. In some embodiments, the method 500 includes receiving 504 information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

In some embodiments, the semi-static cell specific information is implemented using radio resource control common signaling In certain embodiments, the semi-static user equipment specific signaling is implemented using radio resource control dedicated signaling. In various embodiments, the dynamic user equipment specific signaling is implemented using dedicated downlink control information or using group common downlink control information that indicates dynamic switching between the listen-before-talk mode of operation and the non-listen-before-talk mode of operation to fulfil at least one condition.

In one embodiment, switching criteria is determined based on measurement of reference signal received power, reported reference signal received quality, a percentage of hybrid automatic repeat request reports received, a ratio corresponding to a number of hybrid automatic repeat request reports received, a number of consecutive hybrid automatic repeat request reports received, or some combination thereof. In some embodiments, switching between the listen-before-talk mode of operation and the non-listen-before-talk mode of operation is cell specific, user equipment specific, user equipment beam specific, or for a set of beams.

In certain embodiments, the method 500 further comprises receiving a radio network temporary identifier for reception of group common downlink control information indicating switching between the listen-before-talk mode of operation and the non-listen-before-talk mode of operation. In various embodiments, the method 500 further comprises transmitting a request for switching between the listen-before-talk mode of operation and the non-listen-before-talk mode of operation via a scheduling resource or a random access channel transmission.

In one embodiment, the method 500 further comprises determining a time for switching after reception of a switching indication in a current ongoing carrier occupancy time, wherein the time for switching between the listen-before-talk mode of operation and the non-listen-before-talk mode of operation is performed after completion of the current carrier occupancy time. In some embodiments, the method 500 further comprises determining a time for switching after reception of a switching indication in a current ongoing carrier occupancy time, wherein the time for switching between the listen-before-talk mode of operation and the non-listen-before-talk mode of operation is performed immediately from a next slot.

In certain embodiments, the method 500 further comprises determining a time for switching after reception of a switching indication in a current ongoing carrier occupancy time, wherein the time for switching between the listen-before-talk mode of operation and the non-listen-before-talk mode of operation is performed immediately by terminating the current carrier occupancy time and imitating a new carrier occupancy time. In various embodiments, the method 500 further comprises initiating the listen-before-talk mode of operation or the non-listen-before-talk mode of operation using an independent maximum carrier occupancy time.

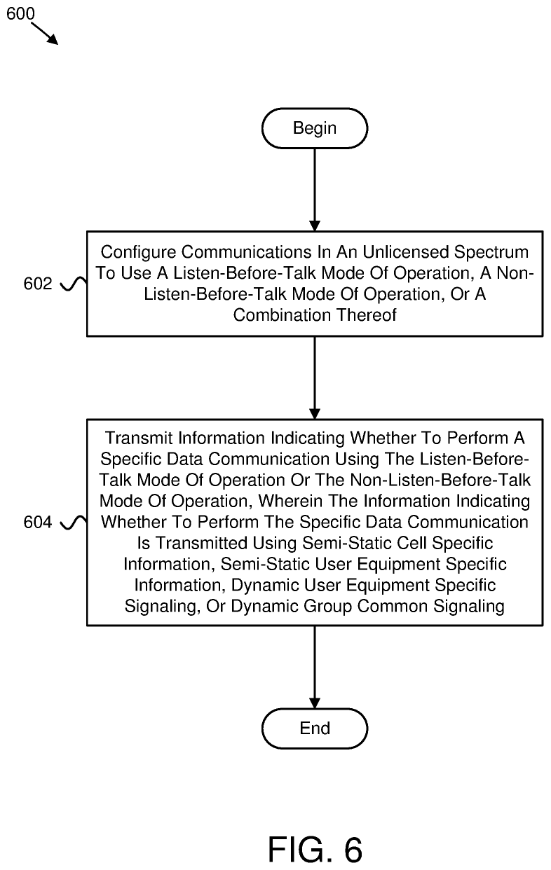

FIG. 6 is a flow chart diagram illustrating another embodiment of a method 600 for optionally performing a listen-before-talk operation. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes configuring 602 communications in an unlicensed spectrum to use a listen-before-talk mode of operation, a non-listen-before-talk mode of operation, or a combination thereof. In some embodiments, the method 600 includes transmitting 604 information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling.

In some embodiments, the semi-static cell specific information is implemented using radio resource control common signaling In certain embodiments, the semi-static user equipment specific signaling is implemented using radio resource control dedicated signaling. In various embodiments, the dynamic user equipment specific signaling is implemented using dedicated downlink control information or using group common downlink control information that indicates dynamic switching between the listen-before-talk mode of operation and the non-listen-before-talk mode of operation to fulfil at least one condition.

In one embodiment, switching criteria is determined based on measurement of reference signal received power, reported reference signal received quality, a percentage of hybrid automatic repeat request reports received, a ratio corresponding to a number of hybrid automatic repeat request reports received, a number of consecutive hybrid automatic repeat request reports received, or some combination thereof. In some embodiments, switching between the listen-before-talk mode of operation and the non-listen-before-talk mode of operation is cell specific, user equipment specific, user equipment beam specific, or for a set of beams.

In certain embodiments, the method 600 further comprises transmitting a radio network temporary identifier for reception of group common downlink control information indicating switching between the listen-before-talk mode of operation and the non-listen-before-talk mode of operation. In various embodiments, the method 600 further comprises receiving a request for switching between the listen-before-talk mode of operation and the non-listen-before-talk mode of operation via a scheduling resource or a random access channel transmission.

In one embodiment, a method of a user equipment comprises: configuring communications in an unlicensed spectrum to use a listen-before-talk mode of operation, a non-listen-before-talk mode of operation, or a combination thereof; and receiving information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

In some embodiments, the semi-static cell specific information is implemented using radio resource control common signaling.

In certain embodiments, the semi-static user equipment specific signaling is implemented using radio resource control dedicated signaling.

In various embodiments, the dynamic user equipment specific signaling is implemented using dedicated downlink control information or using group common downlink control information that indicates dynamic switching between the listen-before-talk mode of operation and the non-listen-before-talk mode of operation to fulfil at least one condition.

In one embodiment, switching criteria is determined based on measurement of reference signal received power, reported reference signal received quality, a percentage of hybrid automatic repeat request reports received, a ratio corresponding to a number of hybrid automatic repeat request reports received, a number of consecutive hybrid automatic repeat request reports received, or some combination thereof.

In some embodiments, switching between the listen-before-talk mode of operation and the non-listen-before-talk mode of operation is cell specific, user equipment specific, user equipment beam specific, or for a set of beams.

In certain embodiments, the method further comprises receiving a radio network temporary identifier for reception of group common downlink control information indicating switching between the listen-before-talk mode of operation and the non-listen-before-talk mode of operation.

In various embodiments, the method further comprises transmitting a request for switching between the listen-before-talk mode of operation and the non-listen-before-talk mode of operation via a scheduling resource or a random access channel transmission.

In one embodiment, the method further comprises determining a time for switching after reception of a switching indication in a current ongoing carrier occupancy time, wherein the time for switching between the listen-before-talk mode of operation and the non-listen-before-talk mode of operation is performed after completion of the current carrier occupancy time.

In some embodiments, the method further comprises determining a time for switching after reception of a switching indication in a current ongoing carrier occupancy time, wherein the time for switching between the listen-before-talk mode of operation and the non-listen-before-talk mode of operation is performed immediately from a next slot.

In certain embodiments, the method further comprises determining a time for switching after reception of a switching indication in a current ongoing carrier occupancy time, wherein the time for switching between the listen-before-talk mode of operation and the non-listen-before-talk mode of operation is performed immediately by terminating the current carrier occupancy time and imitating a new carrier occupancy time.

In various embodiments, the method further comprises initiating the listen-before-talk mode of operation or the non-listen-before-talk mode of operation using an independent maximum carrier occupancy time.

In one embodiment, an apparatus comprises a user equipment. The apparatus further comprises: a processor that configures communications in an unlicensed spectrum to use a listen-before-talk mode of operation, a non-listen-before-talk mode of operation, or a combination thereof; and a receiver that receives information indicating whether to perform a specific data communication using the listen-before-talk mode of operation or the non-listen-before-talk mode of operation. The information indicating whether to perform the specific data communication is received using semi-static cell specific information, semi-static user equipment specific information, dynamic user equipment specific signaling, or dynamic group common signaling.

In some embodiments, the semi-static cell specific information is implemented using radio resource control common signaling.

In certain embodiments, the semi-static user equipment specific signaling is implemented using radio resource control dedicated signaling.

In various embodiments, the dynamic user equipment specific signaling is implemented using dedicated downlink control information or using group common downlink control information that indicates dynamic switching between the listen-before-talk mode of operation and the non-listen-before-talk mode of operation to fulfil at least one condition.

In one embodiment, switching criteria is determined based on measurement of reference signal received power, reported reference signal received quality, a percentage of hybrid automatic repeat request reports received, a ratio corresponding to a number of hybrid automatic repeat request reports received, a number of consecutive hybrid automatic repeat request reports received, or some combination thereof.

In some embodiments, switching between the listen-before-talk mode of operation and the non-listen-before-talk mode of operation is cell specific, user equipment specific, user equipment beam specific, or for a set of beams.

In certain embodiments, the receiver receives a radio network temporary identifier for reception of group common downlink control information indicating switching between the listen-before-talk mode of operation and the non-listen-before-talk mode of operation.

In various embodiments, the apparatus further comprises a transmitter that transmits a request for switching between the listen-before-talk mode of operation and the non-listen-before-talk mode of operation via a scheduling resource or a random access channel transmission.

In one embodiment, the processor determines a time for switching after reception of a switching indication in a current ongoing carrier occupancy time, and the time for switching between the listen-before-talk mode of operation and the non-listen-before-talk mode of operation is performed after completion of the current carrier occupancy time.

In some embodiments, the processor determines a time for switching after reception of a switching indication in a current ongoing carrier occupancy time, wherein the time for switching between the listen-before-talk mode of operation and the non-listen-before-talk mode of operation is performed immediately from a next slot.

In certain embodiments, the processor determines a time for switching after reception of a switching indication in a current ongoing carrier occupancy time, wherein the time for switching between the listen-before-talk mode of operation and the non-listen-before-talk mode of operation is performed immediately by terminating the current carrier occupancy time and imitating a new carrier occupancy time.

In various embodiments, the processor initiates the listen-before-talk mode of operation or the non-listen-before-talk mode of operation using an independent maximum carrier occupancy time.

In one embodiment, a method of a network unit comprises: configuring communications in an unlicensed spectrum to use a listen-before-talk mode of operation, a non-listen-before-talk mode of operation, or a combination thereof; and transmitting information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling.

In some embodiments, the semi-static cell specific information is implemented using radio resource control common signaling.

In certain embodiments, the semi-static user equipment specific signaling is implemented using radio resource control dedicated signaling.

In various embodiments, the dynamic user equipment specific signaling is implemented using dedicated downlink control information or using group common downlink control information that indicates dynamic switching between the listen-before-talk mode of operation and the non-listen-before-talk mode of operation to fulfil at least one condition.

In one embodiment, switching criteria is determined based on measurement of reference signal received power, reported reference signal received quality, a percentage of hybrid automatic repeat request reports received, a ratio corresponding to a number of hybrid automatic repeat request reports received, a number of consecutive hybrid automatic repeat request reports received, or some combination thereof.

In some embodiments, switching between the listen-before-talk mode of operation and the non-listen-before-talk mode of operation is cell specific, user equipment specific, user equipment beam specific, or for a set of beams.

In certain embodiments, the method further comprises transmitting a radio network temporary identifier for reception of group common downlink control information indicating switching between the listen-before-talk mode of operation and the non-listen-before-talk mode of operation.

In various embodiments, the method further comprises receiving a request for switching between the listen-before-talk mode of operation and the non-listen-before-talk mode of operation via a scheduling resource or a random access channel transmission.

In one embodiment, an apparatus comprises a network unit. The apparatus further comprises: a processor that configures communications in an unlicensed spectrum to use a listen-before-talk mode of operation, a non-listen-before-talk mode of operation, or a combination thereof; and a transmitter that transmits information indicating whether to perform a specific data communication using the listen-before-talk mode of operation or the non-listen-before-talk mode of operation. The information indicating whether to perform the specific data communication is transmitted using semi-static cell specific information, semi-static user equipment specific information, dynamic user equipment specific signaling, or dynamic group common signaling.

In some embodiments, the semi-static cell specific information is implemented using radio resource control common signaling.

In certain embodiments, the semi-static user equipment specific signaling is implemented using radio resource control dedicated signaling.

In various embodiments, the dynamic user equipment specific signaling is implemented using dedicated downlink control information or using group common downlink control information that indicates dynamic switching between the listen-before-talk mode of operation and the non-listen-before-talk mode of operation to fulfil at least one condition.

In one embodiment, switching criteria is determined based on measurement of reference signal received power, reported reference signal received quality, a percentage of hybrid automatic repeat request reports received, a ratio corresponding to a number of hybrid automatic repeat request reports received, a number of consecutive hybrid automatic repeat request reports received, or some combination thereof.

In some embodiments, switching between the listen-before-talk mode of operation and the non-listen-before-talk mode of operation is cell specific, user equipment specific, user equipment beam specific, or for a set of beams.

In certain embodiments, the transmitter transmits a radio network temporary identifier for reception of group common downlink control information indicating switching between the listen-before-talk mode of operation and the non-listen-before-talk mode of operation.

In various embodiments, the apparatus further comprises a receiver that receives a request for switching between the listen-before-talk mode of operation and the non-listen-before-talk mode of operation via a scheduling resource or a random access channel transmission.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for wireless communication, the method comprising:
configuring communications in an unlicensed spectrum to use a listen-before-talk (LBT) mode of operation, a non-LBT mode of operation, or a combination thereof; and
receiving information indicating whether to perform a specific data communication using the LBT mode of operation or the non-LBT mode of operation, wherein the information indicating whether to perform the specific data communication is received using semi-static cell specific information, semi-static user equipment (UE) specific information, dynamic UE specific signaling, or dynamic group common signaling.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. An apparatus for wireless communication, the apparatus comprising:
a processor; and
a memory coupled to the processor, the memory comprising instructions executable by the processor to cause the apparatus to:
configure communications in an unlicensed spectrum to use a listen-before-talk (LBT) mode of operation, a non-LBT mode of operation, or a combination thereof; and
receive information indicating whether to perform a specific data communication using the LBT mode of operation or the non-LBT mode of operation, wherein the information indicating whether to perform the specific data communication is received using semi-static cell specific information, semi-static user equipment (UE) specific information, dynamic UE specific signaling, or dynamic group common signaling.

14. The apparatus of claim 13, wherein the semi-static cell specific information is implemented using radio resource control (RRC) common signaling.

15. The apparatus of claim 13, wherein the semi-static UE specific signaling is implemented using radio resource control (RRC) dedicated signaling.

16. The apparatus of claim 13, wherein the dynamic UE specific signaling is implemented using dedicated downlink control information (DCI) or using group common DCI that indicates dynamic switching between the LBT mode of operation and the non-LBT mode of operation to fulfil at least one condition.

17. The apparatus of claim 13, wherein switching criteria is determined based on measurement of reference signal received power (RSRP), reported reference signal received quality (RSRQ), a percentage of hybrid automatic repeat request (HARQ) reports received, a ratio corresponding to a number of HARQ reports received, a number of consecutive HARQ reports received, or a combination thereof.

18. The apparatus of claim 13, wherein switching between the LBT mode of operation and the non-LBT mode of operation is cell specific, UE specific, UE beam specific, or for a set of beams.

19. The apparatus of claim 13, wherein the instructions are further executable by the processor to cause the apparatus to receive a radio network temporary identifier (RNTI) for reception of group common downlink control information (DCI) indicating switching between the LBT mode of operation and the non-LBT mode of operation.

20. The apparatus of claim 13, wherein the instructions are further executable by the processor to cause the apparatus to transmit a request for switching between the LBT mode of operation and the non-LBT mode of operation via a scheduling resource or a random access channel (RACH) transmission.

21. The apparatus of claim 13, wherein the instructions are further executable by the processor to cause the apparatus to determine a time for switching after reception of a switching indication in a current ongoing carrier occupancy time (COT), and the time for switching between the LBT mode of operation and the non-LBT mode of operation is performed after completion of the current COT.

22. The apparatus of claim 13, wherein the instructions are further executable by the processor to cause the apparatus to determine time for switching after reception of a switching indication in a current ongoing carrier occupancy time (COT), wherein the time for switching between the LBT mode of operation and the non-LBT mode of operation is performed immediately from a next slot.

23. The apparatus of claim 13, wherein the instructions are further executable by the processor to cause the apparatus to determine a time for switching after reception of a switching indication in a current ongoing carrier occupancy time (COT), wherein the time for switching between the LBT mode of operation and the non-LBT mode of operation is performed immediately by terminating the current COT and imitating a new COT.

24. The apparatus of claim 13, wherein the instructions are further executable by the processor to cause the apparatus to initiate the LBT mode of operation or the non-LBT mode of operation using an independent maximum carrier occupancy time (COT).

25. (canceled)

26. (canceled)

27. (canceled)

28. (canceled)

29. (canceled)

30. (canceled)

31. (canceled)

32. (canceled)

33. An apparatus for wireless communication, the apparatus comprising:
a processor; and
a memory coupled to the processor, the memory comprising instructions executable by the processor to cause the apparatus to:
configure communications in an unlicensed spectrum to use a listen-before-talk (LBT) mode of operation, a non-LBT mode of operation, or a combination thereof; and
transmit information indicating whether to perform a specific data communication using the LBT mode of operation or the non-LBT mode of operation, wherein the information indicating whether to perform the specific data communication is transmitted using semi-static cell specific information, semi-static user equipment (UE) specific information, dynamic UE specific signaling, or dynamic group common signaling.

34. The apparatus of claim 33, wherein the semi-static cell specific information is implemented using radio resource control (RRC) common signaling.

35. The apparatus of claim 33, wherein the semi-static UE specific signaling is implemented using radio resource control (RRC) dedicated signaling.

36. The apparatus of claim 33, wherein the dynamic UE specific signaling is implemented using dedicated downlink control information (DCI) or using group common DCI that indicates dynamic switching between the LBT mode of operation and the non-LBT mode of operation to fulfil at least one condition.

37. The apparatus of claim 33, wherein switching criteria is determined based on measurement of reference signal received power (RSRP), reported reference signal received quality (RSRQ), a percentage of hybrid automatic repeat request (HARQ) reports received, a ratio corresponding to a number of HARQ reports received, a number of consecutive HARQ reports received, or a combination thereof.

38. The apparatus of claim 33, wherein switching between the LBT mode of operation and the non-LBT mode of operation is cell specific, UE specific, UE beam specific, or for a set of beams.

39. The apparatus of claim 33, wherein the instructions are further executable by the processor to cause the apparatus to transmit a radio network temporary identifier (RNTI) for reception of group common downlink control information (DCI) indicating switching between the LBT mode of operation and the non-LBT mode of operation.

40. (canceled)
